(19) United States
(12) Patent Application Publication
(10) Pub. No.: US 2010/0238325 A1
(43) Pub. Date: Sep. 23, 2010

(54) IMAGE PROCESSOR AND RECORDING MEDIUM

(75) Inventors: Hiroyuki HOSHINO, Tokyo (JP); Jun Muraki, Tokyo (JP); Hiroshi Shimizu, Tokyo (JP); Erina Ichikawa, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/727,816

(22) Filed: Mar. 19, 2010

(30) Foreign Application Priority Data
Mar. 19, 2009 (JP) 2009-068030

(51) Int. Cl. H04N 9/74; H04N 5/262

(52) U.S. Cl. 348/239; 348/586; 348/E09.055; 348/E05.051

(57) ABSTRACT

A camera device 100 comprises a CPU 13, a characteristic area specifier 8d, and a combine subunit 8f. CPU 13 detects a command to combine a background image and a foreground image. In response to detection of the command by CPU 13, the characteristic area specifier 8d specifies a foreground area for the foreground image. The combine subunit 8f combines the background image and the foreground image such that the foreground area specified by the characteristic area specifier 8d is in front of the foreground image.

### CROSS-REFERENCE TO RELATED APPLICATIONS

This application is based on Japanese Patent Application No. 2009-068030 filed on Mar. 19, 2009 and including specification, claims, drawings and summary. The disclosure of the above Japanese patent application is incorporated herein by reference in its entirety.

### BACKGROUND OF THE INVENTION

1. Field of the Invention

The present invention relates to image processors and recording mediums which combine with a plurality of images to a combined image.

2. Description of Background Art

Techniques for combining a subject image and a background image or a frame image to a combined image are known, as disclosed in JP 2004-159158. However, mere combine of the subject image and the background image might produce an unnatural image. In addition, even combine of the subject image and a background image with an emphasized stereophonic effect would produce nothing but mere superimposition of these images which only gives a monotonous expression.

### SUMMARY OF THE INVENTION

It is therefore an object of the present invention to provide an image processor and recording medium for producing a combined image with little sense of discomfort.

In accordance with an aspect of the present invention, there is provided an image combine apparatus comprising: a detection unit configured to detect a command to combine a background image and a foreground image; a specifying unit configured to specify, responsive to the detecting the command, a foreground area to be present in front of the foreground image; and a combine subunit configured to combine the background image and the foreground image such that the foreground area is disposed in front of the foreground image.

In accordance with an another aspect of the present invention, there is provided a software program product embodied in a computer readable medium for causing the computer to function as: a detection unit configured to detect a command to combine a background image and a foreground image; a specifying unit configured to specify, responsive to the detecting the command, a foreground area to be present in front of the foreground image responsive to the detecting the command; and a combine subunit configured to combine the background image and the foreground image such that the foreground area is disposed in front of the foreground image.

The accompanying drawings, which are incorporated in and constitute a part of the specification, illustrate presently preferred embodiments of the present invention and, together with the general description given above and the detailed description of the preferred embodiments given below, serve to explain the principles of the present invention.

### BRIEF DESCRIPTION OF THE DRAWINGS

FIG. 1 is a block diagram of a schematic structure of a camera device according to one embodiment of the present invention.

FIG. 2 is a flowchart indicative of a process for cutting out a subject image from a subject-background image which includes an image of a subject and its background by the camera device of FIG. 1.

FIG. 3 is a flowchart indicative of a background image capturing process by the camera device of FIG. 1.

FIG. 4 is a flowchart indicative of a combined image producing process by the camera device of FIG. 1.

FIG. 5 is a flowchart indicative of an image combining step of the combined image producing process of FIG. 4.

FIGS. 6A and B schematically illustrate one example of an image involving a process for extracting the subject image from subject-background image of FIG. 2.

FIGS. 7A, B and C schematically illustrate one example of an image to be combined in the combined image producing process of FIG. 4.

FIGS. 8A and B schematically illustrate another combined image involving the combined image producing process of FIG. 4.

FIG. 9 is a flowchart indicative of a modification of the combined image producing process by the camera device of FIG. 1.

### DETAILED DESCRIPTION OF THE INVENTION

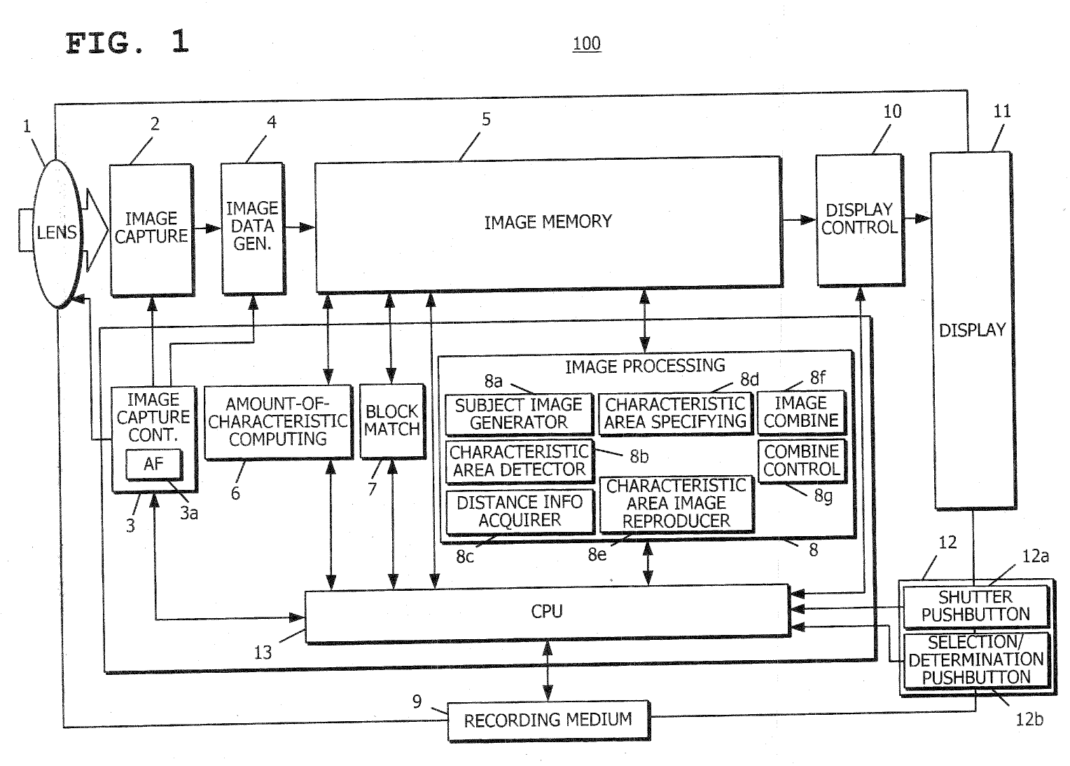

Referring to FIG. 1, the camera device 100 according to an embodiment of the present invention will be described.

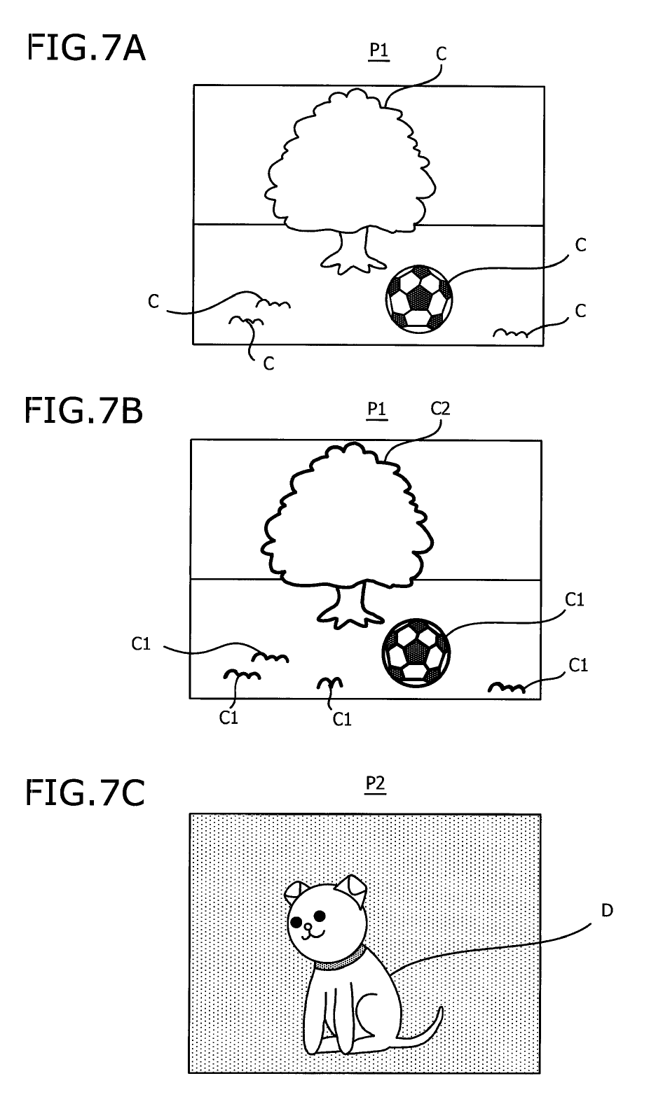

In FIGS. 7A-C, the camera device 100 of this embodiment detects a plurality of characteristics areas C from a background image P1 for a subject image D. The camera device 100 also specifies, among the plurality of characteristic areas, characteristic areas C1 which will be a foreground for the subject image D in a non-display area-subject image P2, which includes an image of a non-display area and the subject image D. Assume that the areas C1 and C2 are a foreground image and a background image, respectively, for the subject image D. The camera device 100 combines the background image P1 and the subject image D such that the area C1 is a foreground for the subject image D.

As shown in FIG. 1, the camera device 100 comprises a lens unit 1, an electronic image capture unit 2, an image capture control unit 3, an image data generator 4, an image memory 5, an amount-of-characteristic computing unit 6, a block matching unit 7, an image processing subunit 8, a recording medium 9, a display control unit 10, a display 11, an operator input unit 12 and a CPU 13. The image capture control unit 3, amount-of-characteristic computing unit 6, block matching unit 7, image processing subunit 8, and CPU 13 are designed, for example, as a custom LSI in the camera.

The lens unit 1 is comprised of a plurality of lenses including a zoom and a focus lens. The lens unit 1 may include a zoom driver (not shown) which moves the zoom lens along an optical axis thereof when a subject image is captured, and a focusing driver (not shown) which moves a focus lens along the optical axis.

The electronic image capture unit 2 comprises an image sensor such as a CCD (Charge Coupled Device) or a CMOS (Complementary Metal-Oxide Semiconductor) sensor which functions to convert an optical image which has passed through the respective lenses of the lens unit 1 to a 2-dimensional image signal.

The image capture control unit 3 comprises a timing generator and a driver (none of which are shown) to cause the electronic image capture unit 2 to scan and periodically convert an optical image to a 2-dimensional image signal, reads image frames one by one from an imaging area of the electronic image capture unit 2 and then outputs them sequentially to the image data generator 4.

The image capture control unit 3 adjusts conditions for capturing an image of the subject. The image capture control unit 3 includes an AF (Auto Focusing) which performs an auto focusing process which includes moving the lens unit 1 along the optical axis to adjust focusing conditions, and an AE (Auto Exposing) and AWB (Auto White Balancing) process which adjust image capturing conditions.

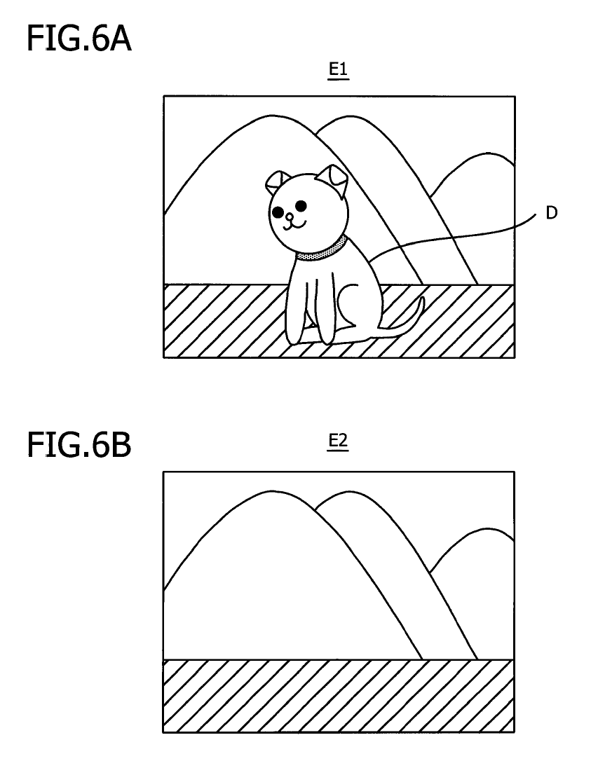

The lens unit 1, the electronic image capture unit 2 and the image capture control unit 3 cooperate to capture the background image P1 (see FIG. 7A) and a subject-background image E1 (see FIG. 6A) which includes the subject image D and its background. The background image P1 and the subject-background image E1 are involved in the image combining process.

After the subject-background image E1 has been captured, the lens unit 1, the capture unit 2 and the image capture control unit 3 cooperate to capture a background-only image E2 (FIG. 6B) which includes an image of a background only to produce a non-display area-subject image P2 (FIG. 7C), in a state where the same image capturing conditions as set when the subject-background image E1 was captured are maintained. The non-display area-subject image P2 includes an image of a non-display area and a subject.

The image data generator 4 appropriately adjusts the gain of each of R, G and B color components of an analog signal representing an image frame transferred from the electronic image capture unit 2. Then, the image data generator 4 samples and holds a resulting analog signal in a sample and hold circuit (not shown) thereof and then converts a second resulting signal to digital data in an A/D converter (not shown) thereof. Then, the image data generator 4 performs, on the digital data, a color processing process including a pixel interpolating process and a γ-correcting process in a color processing circuit (not shown) thereof. Then, the image data generator 4 generates a digital luminance signal Y and color difference signals Cb, Cr (YUV data).

The luminance signal Y and color difference signals Cb, Cr outputted from the color processing circuit are DMA transferred via a DMA controller (not shown) to the image memory 5 which is used as a buffer memory.

The image memory 5 comprises, for example, a DRAM which temporarily stores data processed and to be processed by each of the amount-of-characteristic computing unit 6, block matching unit 7, image processing subunit 8 and CPU 13.

The amount-of-characteristic computing unit 6 performs a characteristic extracting process which includes extracting characteristic points from the background-only image E2 based on this image only. More specifically, the amount-of-characteristic computing unit 6 selects a predetermined number of or more block areas of high characteristics (characteristic points) based, for example, on YUV data of the background-only image E2 and then extracts the contents of the block areas as a template (for example, of a square of 16×16 pixels).

The characteristic extracting process includes selecting block areas of high characteristics convenient to track from among many candidate blocks.

The block matching unit 7 performs a block matching process for causing the background-only image E2 and the subject-background image E1 to coordinate with each other when the non-display area-subject image P2 is produced. More specifically, the block matching unit 7 searches for areas or locations in the subject-background image E1 where the pixel values of the subject-background image E1 optimally match the pixel values of the template.

Then, the block matching unit 7 computes a degree of dissimilarity between each pair of corresponding pixel values of the template and the subject-background image E1 in a respective one of the locations or areas. Then, the block matching unit 7 computes, for each location or area, an evaluation value involving all those degrees of dissimilarity (for example, represented by Sum of Squared Differences (SSD) or Sum of Absolute Differences (SAD)), and also computes, as a motion vector for the template, an optimal offset between the background-only image E2 and the subject-background image E1 based on the smallest one of the evaluated values.

The image processing subunit 8 comprises a subject image generator 8a which generates image data of the non-display area-subject image P2 and includes an image coordinator, a subject area extractor, a position information generator and a subject image subgenerator (not shown).

The image coordination unit computes a coordinate transformation expression (projective transformation matrix) for the respective pixels of the subject-background image E1 to the background-only image E2 based on each of the block areas of high characteristics extracted from the background-only image E2. Then, the image coordination unit performs coordinate transformation on the subject-background image E1 in accordance with the coordinate transform expression, and then coordinates a resulting image and the background-only image E2.

The subject image extractor generates difference information between each pair of corresponding pixels of the coordinated subject-background image E1 and background-only image E2. Then, the subject image extractor extracts the subject image D from the subject-background picture E1 based on the difference information.

The position information generator specifies the position of the subject image D extracted from the subject-background image E1 and then generates information indicative of the position of the subject image D in the subject-background image E1 (for example, alpha map).

In the map, the pixels of the subject-background image E1 each are given a weight represented by an alpha (α) value where 0≦α≦1 with which the subject image D is alpha blended with a predetermined background.

The subject image subgenerator combines the subject image D and a predetermined monochromatic image (not shown) such that among the pixels of the subject-background image E1, pixels with an alpha value of 0 are not displayed to the monochromatic image and that pixels with an alpha value of 1 are displayed, thereby generating image data of the non-display area-subject image P2.

The image processing subunit 8 comprises a characteristic area detector 8b which detects characteristic areas C in the background image P1. The characteristic area detector 8b specifies and detects characteristic areas C such as a ball and/or vegetation (see FIG. 7B) in the image based on changes in its contrast, using color information of the image data, for example. The characteristic areas C may be detected by extracting their respective outlines, using an edge of adjacent pixel values of the background image P1.

The image processing subunit 8 comprises a distance information acquirer 8c which acquires information on a distance from the camera device 100 to a subject whose image is captured by the cooperation of the lens unit 1, the electronic image capture unit 2 and the image capture control unit 3. When the electronic image capture unit 2 captures the background image P1, the distance information acquirer 8c acquires information on the distances from the camera device 100 to the respective areas C.

More specifically, the distance information acquirer (DIA) 8c acquires information on the position of the focus lens on its axis moved by the focusing driver (not shown) from an AF section 3a of the image capture control unit 3 in the auto focusing process, and then acquires information on the distances from the camera device 100 to the respective areas C based on the position information of the focus lens. Also, when the electronic image capture unit 2 captures the subject-background image E1, the distance information acquirer 8c acquires, from the AF section 3a of the image capture control unit 3, position information of the focus lens on its optical axis moved by the focusing driver (not shown) in the auto focusing process, and then acquires information on the distance from the camera device 100 to the subject based on the lens position information.

Acquisition of the distance information may be performed by executing a predetermined conversion program or table.

The image processing subunit 8 comprises a characteristic area specifying unit 8d for specifying a foreground area C1 disposed in front of the subject image D in the non-display area-subject image P2 among the plurality of areas C detected by the characteristic area detector 8b.

More specifically, the characteristic area specifying unit 8d compares information on the distance from the focus lens to the specified subject and information on the distance from the camera device 100 to each of the characteristic areas C, acquired by the distance information acquirer 8c, thereby determining which of the characteristic areas C is in front of the subject image D. The characteristic area specifying unit 8d then specifies, as a foreground area C1, a characteristic area C determined to be located in front of the subject image D.

The image processing subunit 8 comprises a characteristic area image reproducer 8e which reproduces an image of the foreground area C1 specified by the characteristic area specifying unit 8d. More specifically, the characteristic image reproducer 8e extracts and reproduces an image of the foreground area C1 specified by the characteristic area specifying unit 8d.

The image processing subunit 8 also comprises an image combine subunit 8f which combines the background image P1 and the non-display area-subject image P2. More specifically, when a pixel of the non-display area-subject image P2 has an alpha value of 0, the image combine subunit 8f does not display a corresponding pixel of the background image P1 in a resulting combined image. When a pixel of the non-display area-subject image P2 has an alpha value of 1, the image combine subunit 8f overwrites a corresponding pixel of the background image P1 with a value of that pixel of the non-display area-subject image P2.

Further, when a pixel of the non-display area subject image P2 has an alpha (α) value where 0<α<1, the image combine subunit 8f produces a subject image-free background image (background image×(1−α)), which includes the background image P1 from which the subject image D is extracted, using a 1's complement or (1−α); computes a pixel value of the monochromatic image when the non-display area-subject image P2 was produced, using the 1's complement or (1−α); subtracts the computed pixel value from the pixel value of a monochromatic image formed potentially on the non-display area-subject image P2; and then combines a resulting version of the non-display area-subject image P2 with the subject-free image (or background image×(1−α)).

The image processing subunit 8 comprises a combine control unit 8g which, when combining the background image P1 and the subject image D, causes the image combine subunit 8f to combine the background image P1 and the subject image D such that the characteristic area C1 specified by the characteristic area specifying unit 8d becomes a foreground image for the subject image D.

More specifically, the combine control unit 8g causes the image combine subunit 8f to combine the background image P1 and subject image D and then to combine a resulting combined image and the image of the foreground area C1 reproduced by the characteristic image reproducer 8e such that the characteristic area C1 is a foreground image for the subject image D in the non-display area-subject image P2. At this time, the foreground area C1 is coordinated so as to return to its original position in the background image P1 based on characteristic area position information on the foreground area C1, which will be described later in more detail, annexed as the Exif information to the image data of the foreground area C1. The combine control unit 8g composes means for causing the image combine subunit 8f to combine the background image P1 and subject image D such that the characteristic area C1 specified by the characteristic area specifying unit 8d is a foreground image for the subject image D.

Thus, an area image such as a ball of FIG. 7B which will overlap with the subject image D is combined with same so as to be a foreground area for the subject image D. On the other hand, a foreground image C1 such as a weed shown in the lower left part of FIG. 7B which does not overlap with the subject image D is not combined with the background image D but the foreground area C is displayed as it is.

The recording medium 9 comprises, for example, a non-volatile (or flash) memory, which stores the image data of the non-display area-subject image P2, the background image P1 and the foreground area C1, which each are encoded by a JPEG compressor (not shown).

The image data of the non-display area-subject image P2 with an extension “.jpe” is stored on the recording medium 9 in correspondence to the alpha map produced by the position information generator of the subject image generator 8a. The image data of the non-display area-subject image P2 is comprised of an image file of an Exif type to which information on the distance from the camera device 100 to the subject acquired by the distance area acquirer 8c is annexed as Exif information.

The image data of the background image P1 is comprised of an image file of an Exif type. When image data of characteristic areas C are contained in the image file of the Exif type, information for specifying the images of the respective areas C and information on the distances from the camera device 100 to the areas C acquired by the distance information acquirer 8c are annexed as Exif information to the image data of the background image P1.

Various information such as characteristic area position information involving the position of the areas C in the background image P1 is annexed as Exif information to the image data of the areas C. The image data of the foreground area C1 is comprised of an image file of an Exif type to which various information such as characteristic area position information involving the position of the foreground area C1 in the background image P1 is annexed as Exif information.

The display control unit 10 reads image data for display stored temporarily in the image memory 5 and displays it on the display 11. The display control unit 10 comprises a VRAM, a VRAM controller, and a digital video encoder (none of which are shown). The video encoder periodically reads the luminance signal Y and color difference signals Cb, Cr, which are read from the image memory 5 and stored in the VRAM under control of CPU 13, from the VRAM via the VRAM controller. Then, the display control unit 10 generates a video signal based on these data and then displays the video signal on the display 11.

The display 11 comprises, for example, a liquid crystal display which displays an image captured by the electronic image capturer 2 based on a video signal from the display control unit 10. More specifically, in the image capturing mode, the display 11 displays live view images based on respective image frames produced by the capture of images of the subject by the cooperation of the lens unit 1, the electronic image capturer 2 and the image capture control unit 3, and also displays actually captured images on the display 11.

The operator input unit 12 is used to operate the camera device 100. More specifically, the operator input unit 12 comprises a shutter pushbutton 12a to give a command to capture an image of a subject, a selection/determination pushbutton 12b which, in accordance with a manner of operating the pushbutton 12b, selects and gives one of a command to select one of a plurality of image capturing modes or functions or one of a plurality of displayed images, a command to set image capturing conditions and a command to set a combining position of the subject image P3, and a zoom pushbutton (not shown) which gives a command to adjust a quantity of zooming. The operator input unit 12 provides an operation command signal to CPU 13 in accordance with operation of a respective one of these pushbuttons.

CPU 13 controls associated elements of the camera device 100, more specifically, in accordance with corresponding processing programs (not shown) stored in the camera. CPU 13 also detects a command to combine the background image and the subject image D due to operation of the selection/determination pushbutton 12b.

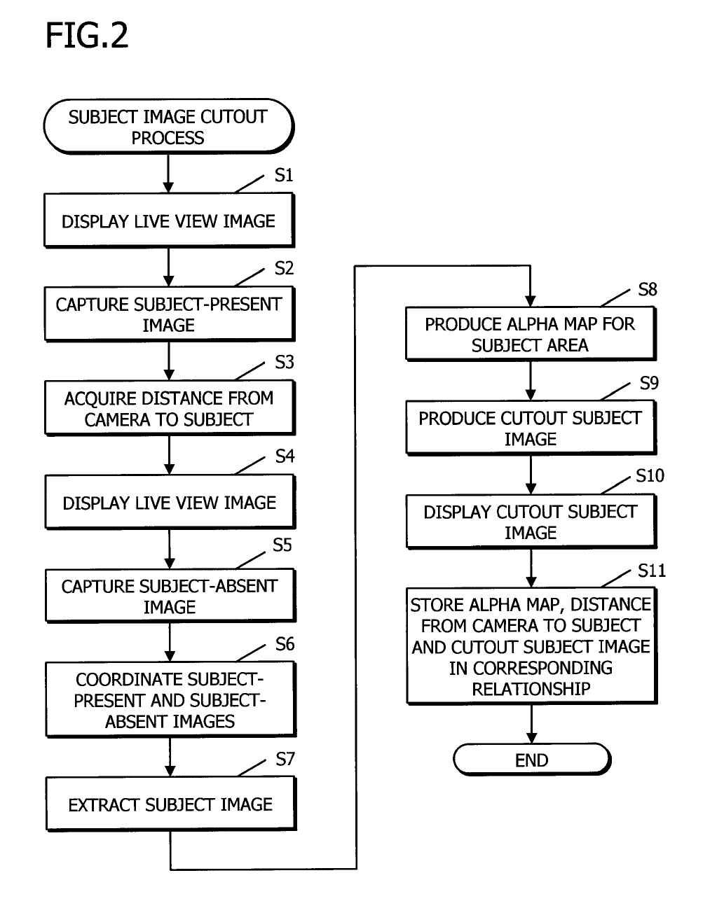

Referring to a flowchart of FIG. 2, a process for extracting the subject image only from the subject-background image which is performed by the camera device 100 will be described.

This process is performed when a subject producing mode is selected from among the plurality of image capturing modes displayed on a menu picture, by the operation of the pushbutton 12b of the operator input unit 12.

As shown in FIG. 2, first, CPU 13 causes the display control unit 10 to display live view images on the display 11 based on respective image frames of the subject image captured by the cooperation of the image capturing lens unit 1, the electronic image capture unit 2 and the image capture control unit 3. CPU 13 also causes the display control unit 10 to display, on the display 11, a message to request to capture a subject-background image E1 so as to be superimposed on the live view images (step S1).

Then, CPU 13 causes the image capture control unit 3 to adjust a focused position of the focus lens. When the shutter pushbutton 12a is operated, the image capturing control unit 3 controls the image capture unit 2 to capture an optical image indicative of the subject-background image E1 under predetermined image capturing conditions (step S2). Then, CPU 13 causes the distance information acquirer 8c to acquire information on the distance from the camera device 100 on the optical axis to the subject (step S3). YUV data of the subject-background image E1 produced by the image data generator 4 is stored temporarily in the image memory 5.

CPU 13 also controls the image capture control unit 3 so as to maintain the same image capturing conditions including the focused position of the focus lens, the exposure conditions and the white balance as set when the subject-background image E1 was captured.

Then, CPU 13 also causes the display control unit 10 to display, on the display 11, live view images based on respective image frames of the subject image captured by the cooperation of the lens unit 1, the electronic image capture unit 2 and the image capture control unit 3. CPU 13 also causes the display 11 to display a message to request to capture a translucent image indicative of the subject-background image E1 and the background-only image such that these images are displayed superimposed, respectively, on the live view images on the display 11 (step S4). Then, the user moves the subject out of the angle of view or waits for the subject to move out of the angle of view, and then captures the background-only image E2.

Then, the user adjusts the camera position such that the background-only image E2 is superimposed on a translucent image indicative of the subject-background image E1. When the user operates the shutter pushbutton 12a, CPU 13 controls the image capture control unit 3 such that the electronic image capture unit 2 captures an optical image indicative of the background-only image E2 under the same image capturing conditions as the subject-background image E1 was captured (step S5). The YUV data of the background-only image E2 produced by the image data generator 4 is then stored temporarily in the image memory 5.

Then, CPU 13 causes the amount-of-characteristic computing unit 6, the block matching unit 7 and the image processing subunit 8 to cooperate to compute, in a predetermined image transformation model (such as, for example, a similar transformation model or a congruent transformation model), a projective transformation matrix to projectively transform the YUV data of the subject-background image E1 based on the YUV data of the background-only image E2 stored temporarily in the image memory 5.

More specifically, the amount-of-characteristic computing unit 6 selects a predetermined number of or more block areas (characteristics points) of high characteristics (for example, of contrast values) based on the YUV data of the background-only image E2 and then extracts the contents of the block areas as a template.

Then, the block matching unit 7 searches for locations or areas of pixel values of the subject-background image E1 which the pixel values of each template extracted in the characteristic extracting process match optimally. Then, the block matching unit 7 computes a degree of dissimilarity between each pair of corresponding pixel values of the background-only image E2 and the subject-background image E1. Then, the block matching unit 7 also computes, as a motion vector for the template, an optimal offset between the background-only image E2 and the subject-background image E1 based on the smallest one of the evaluated values.

Then, the coordination unit of the subject-image generator 8a statistically computes a whole motion vector based on the motion vectors for the plurality of templates computed by the block matching unit 7, and then computes a projective conversion matrix of the subject-background image E1, using characteristic point correspondence involving the whole motion vector.

Then, the coordination unit projectively transforms the subject-background image E1 based on the computed projective transformation matrix, and then coordinates the YUV data of the subject-background image E1 and that of the background-only image E2 (step S6).

Then, the subject image area extractor of the subject image generator 8a extracts the subject image D from the subject-background image E1 (step S7). More specifically, the subject image area extractor causes the YUV data of each of the subject-background image E1 and the background-only image E2 to pass through a low pass filter to eliminate high frequency components of the respective images.

Then, the subject image area extractor computes a degree of dissimilarity between each pair of corresponding pixels in the subject-background and background-only images E1 and E2 passed through the low pass filters, respectively, thereby producing a dissimilarity degree map. Then, the subject image area extractor binarises the map with a predetermined threshold, and then performs a shrinking process to eliminate, from the dissimilarity degree map, areas where dissimilarity has occurred due to fine noise and/or blurs.

Then, the subject image area extractor performs a labeling process on the map, thereby to specifying a pattern of a maximum area as the subject image D in the labeled map, and then performs an expanding process to correct possible shrinks which have occurred to the subject image D.

Then, the position information generator of the image processing subunit 8 produces an alpha map indicative of the position of the extracted subject image D in the subject-background image E1 (step S8).

Then, the subject-image subgenerator generates image data of a non-display area-subject image P2 which includes a combined image of the subject image and a predetermined monochromatic image (step S9).

More specifically, the subject image subgenerator reads data on the subject-background image E1, the monochromatic image and the alpha map from the recording medium 9 and loads these data on the image memory 5. Then, the subject image subgenerator causes pixels of the subject-background image E1 with an alpha (α) value of 0 to be not displayed to the monochromatic image. Then, the subject image subgenerator also causes pixels of the subject-background image E1 with an alpha value greater than 0 and smaller than 1 to blend with the predetermined monochromatic pixel. Then, the subject image subgenerator also causes pixels of the subject-background image E1 with an alpha value of 1 to be displayed to the predetermined monochromatic pixel.

Then, based on the image data of the non-display area-subject image P2 produced by the subject image subgenerator, CPU 13 causes the display control unit 10 to display, on the display 11, a non-display area-subject image P2 where the subject image is superimposed on the predetermined monochromatic color image (step S10).

Then, CPU 13 stores a file including the alpha map produced by the position information generator, information on the distance from the focus lens to the subject and image data of the non-display area-subject image P2 with an extension “.jpe” in corresponding relationship to each other in the predetermined area of the recording medium 9 (step S11). CPU 13 then terminates the subject image cutout process.

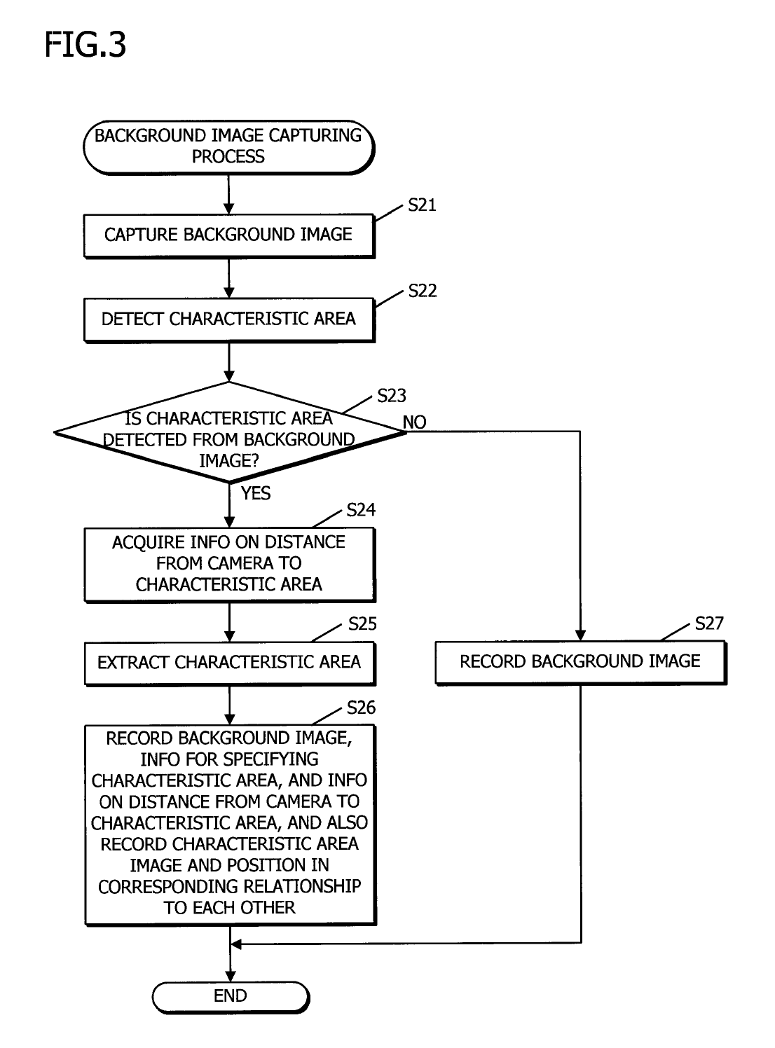

Referring to a flowchart of FIG. 3, a background image capturing process by the camera device 100 will be described. As shown in FIG. 3, first, CPU 13 causes the image capture control unit 3 to adjust the focused position of the focus lens, the exposure conditions (shutter speed, stop, and amplification factor) and the image capturing conditions including white balance. Then, when the user operates the shutter pushbutton 12a, the image capture control unit 3 causes the electronic image capture unit 2 to capture an optical image indicative of the background image P1 (FIG. 7A) under the adjusted image capturing conditions (step S21).

Then, CPU 13 causes the characteristic area detector 8b to specify and detect characteristic areas C (see FIG. 7B) such as a ball and/or vegetation in the image from changes in its contrast, using color information of image data of the background image P1 captured in step S21 (step S22).

Then, the characteristic area detector 8b determines whether a characteristic area C in the background image P1 has been detected (step S23). If it does (step S23, YES), CPU 13 causes the distance information acquirer 8c to acquire, from the AF section 3a of the image capture control unit 3, information on the position of the focus lens on its optical axis moved by the focusing driver (not shown) in the auto focusing process when the background image P1 was captured, and also capture information on the distance from the camera device 100 to the area C based on the position information of the focus lens (step S24).

Then, the characteristic area image reproducer 8e reproduces image data of the area C in the background image P1 (step S25). Then, CPU 13 records, in a predetermined storage area of the recording medium 9, image data of the background image P1 captured in step S21 to which information for specifying an image of the area C and information on the distance from the camera device 100 to the area C are annexed as Exif information, and the image data of the area C to which various information such as information on the position of the characteristic area C in the background image P1 is annexed as Exif information (step S26).

When determining that no areas C have been detected (No in step S23), CPU 13 records, in a predetermined storage area of the recording medium 9, image data of the background image P1 captured in step S21 (step S27) and then terminates the background image capturing process.

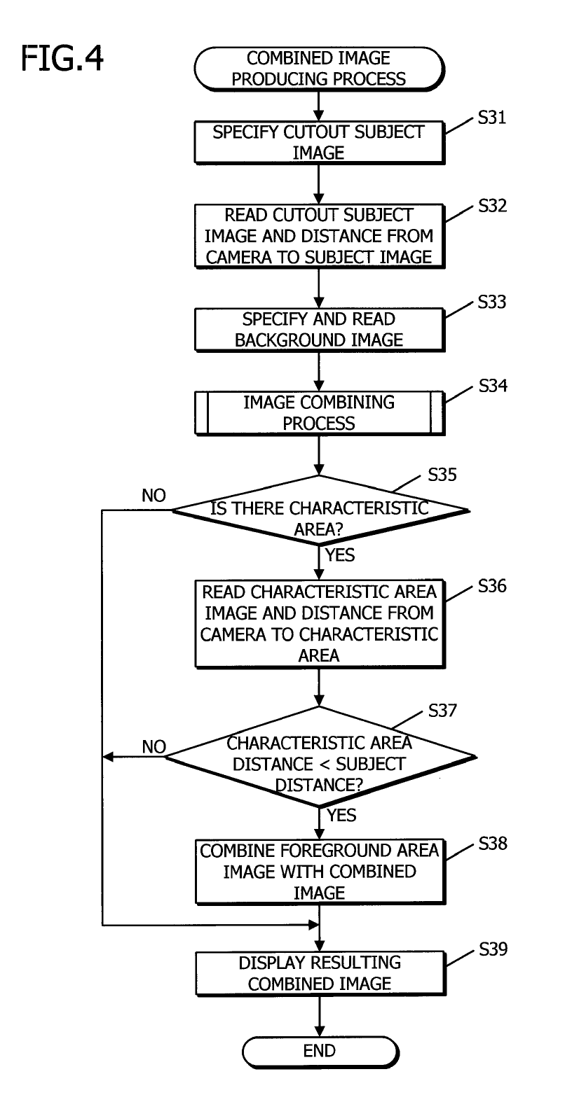

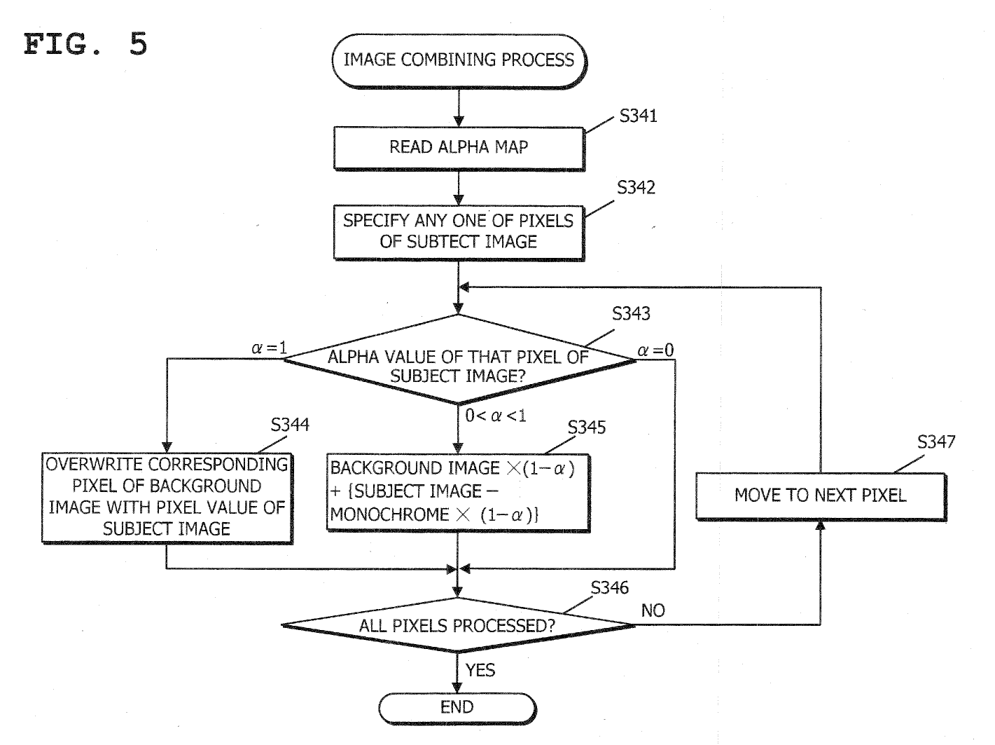

A combined image producing process by the camera 100 will be described with reference to a flowchart of FIGS. 4 and 5. The combined image producing process includes combine of the background image P1 and the subject image D in the non-display area subject image P2 into a combined image, using the combine subunit 8f and the combine control unit 8g of the image processing subunit unit 8.

As shown in FIG. 4, when a desired non-display area-subject image P2 is selected from among of the plurality of images recorded on the recording medium 9 by the operation of the operator input unit 12 (step S31), the image processing subunit 8 reads the image data of the specified non-display area-subject image P2 and loads it on the image memory 5. Then, the characteristic area specifying unit 8d reads information on the distance from the camera device 100 to the subject stored in corresponding relationship to the image data (step S32).

Then, when a desired background image P1 is selected from among the plurality of images recorded on the recording medium 9 by the operation of the operator input unit 12, the image combine subunit 8f reads image data of the selected background image and load it on the display memory 5 (step S33).

Then, the image combine subunit 8f performs an image combining process, using the background image P1, whose image data is loaded on the image memory 5, and the subject image D in the non-display area-subject image P2 (step S34).

Referring to a flowchart of FIG. 5, the image combining process will be described in detail. As shown in FIG. 5, the image combining unit 8f reads an alpha map with the extension “.jpe” stored on the recording medium 9 and loads it on the image memory 5 (step S341).

Then, the image combine subunit 8f specifies any one (for example, an upper left corner pixel) of the pixels of the background image P1 (step S342) and then causes the processing of the pixel to branch to a step specified in accordance with an alpha value (α) of the alpha map (step S343).

More specifically, when a corresponding pixel of the non-display area-subject image P2 has an alpha value of 1 (step S343, α=1), the image combine subunit 8f overwrites that pixel of the background image P1 with a value of the corresponding pixel of the non-display area subject image P2 (step S344).

Further, when the corresponding pixel of the non-display area-subject image P2 has an alpha (α) value where 0<α<1 (step S343, 0<α<1), the image combine subunit 8f produces a subject-free background image (background image×(1−α)), using a 1's complement or (1−α). Then, the image combine subunit 8f computes a pixel value of the monochromatic image used when the non-display area-subject image P2 was produced, using the 1's complement or (1−α) in the alpha map. Then, the image combine subunit 8f subtracts the computed pixel value of the monochromatic image from the pixel value of a monochromatic image formed potentially in the non-display area-subject image P2. Then, the image combine subunit 8f combines a resulting processed version of the non-display area-subject image P2 with the subject-free background image (or background image×(1−α)) (step S345).

When the non-display area-subject image P2 has a pixel with an alpha value of 0 (step S343, α=0), the image combine subunit 8f performs no image processing process on the pixel excluding displaying the background image P1 as the combined image.

Then, the image combine subunit 8f determines whether all the pixels of the background image P1 have been subjected to the image synthesizing process (step S346). If it does not, the image combine subunit 8f shifts its processing to a next pixel (step S347) and then to step S343.

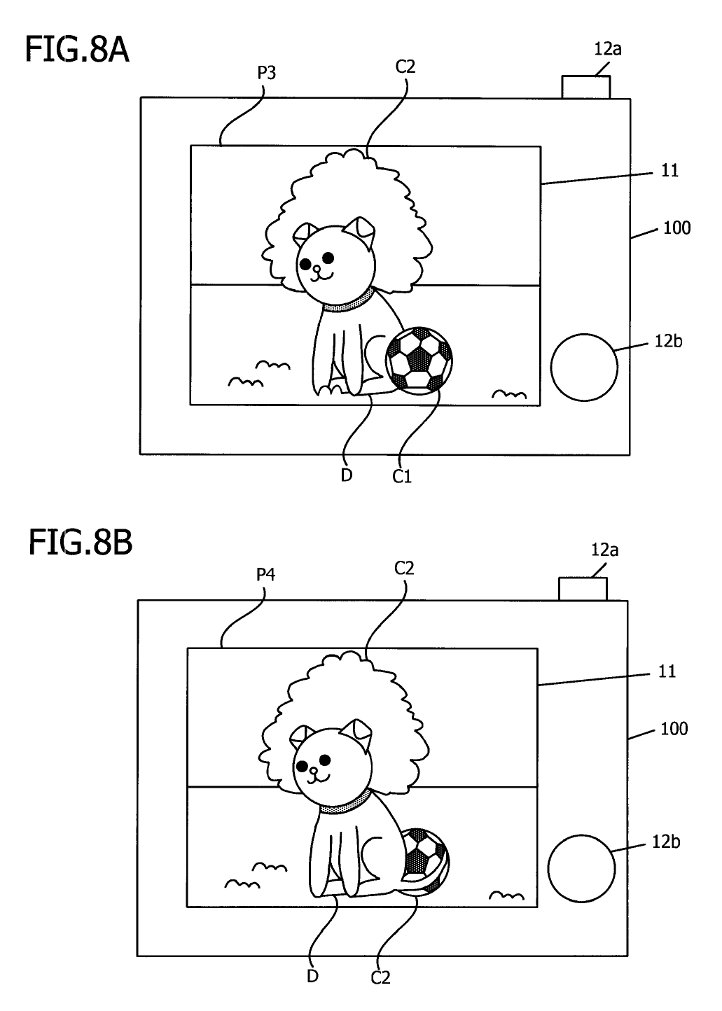

By iterating the above steps S343 to S346 until the image combine subunit 8f determines that all the pixels of the background image P1 have been processed (YES in step S346), the image combine subunit 8f generates image data of a combined image P4 of the subject image D and the background image P1 (FIG. 8B), and then terminates the image combining process.

As shown in FIG. 4, thereafter, CPU 13 determines whether there is image data of a characteristic area C extracted from the read background image P1 based on information for specifying the image of the characteristic area C stored as Exif information in the image data of the background image P1 (step S35).

If it does (YES in step S35), the combine subunit 8f reads the image data of the area C based on the information for specifying the image of the area C stored as Exif information in the image data of the background image P1. Then, the characteristic area specifying unit 8d reads and acquires information on the distance from the camera device 100 to the area C stored in correspondence to the image data of the background image P1 on the recording medium 9 (step S36).

Then, the characteristic area specifying unit 8d determines whether the distance from the camera device 100 to the area C read in step S36 is smaller than the distance from the camera device 100 to the subject read in step S32 (step S37).

If it does, the image combine control unit 8g causes the image combine subunit 8f to combine the image of the area C and a combined image P4 of the superimposed subject image D and background image P1 such that the image of the area C1 becomes a foreground for the subject image D, thereby producing image data of a different combined image P3 (step S38). Subsequently, CPU 13 causes the display control unit 10 to display the different combined image P3 on the display 11 based on its image data (step S39, FIG. 8A).

When not determining that the distance from the camera device 100 to the area C is smaller than that from the camera device 100 to the subject image area (NO in step S37), CPU 13 moves its processing to step S39 and then displays, on the display 11, the combined image P4 of the subject image D and the background image P1 (step S39, FIG. 8B).

When determining that there are no image data of the areas C (NO in step S35), CPU 13 moves its processing to step S39 and then displays, on the display 11, the combined image P4 of the superimposed subject image D and background image P1 (step S39, FIG. 8B), and then terminates the combined image producing process.

As described above, according to the camera device 100 of this embodiment, among the areas C detected from the background image P1, a foreground area C1 for the subject image D is specified. Then, the subject image D and the background image P1 are combined such that the foreground area C1 becomes a foreground for the subject image D. Thus, the subject image can be expressed as if it were in the background of the background image P1, thereby producing a combined image giving little sense of discomfort.

When the background image P1 is captured, information on the respective distances from the camera device 100 to the areas C is acquired, and then a foreground characteristic area C1 is specified based on the acquired distance information. More specifically, when the subject-background image E1 is captured, information on the distance from the camera device 100 to the subject D is acquired, Then, the distance from the camera device 100 to the subject image D is compared to the distance from the camera device 100 to the area C, thereby determining whether the subject image D is in front of the area C. If it does, the area C is specified objectively as a foreground area C1, and thus a combined image of little sense of discomfort is produced appropriately.

Although in the embodiment the foreground image area C1 is illustrated as specified automatically by the characteristic area specifying unit 8d, the method of specifying the characteristic areas is not limited to this particular case. For example, a predetermined area specified by the selection/determination pushbutton 12b may be specified as the foreground area C1.

(Modification)

A modification of the camera device 100 will be described which has an automatically specifying mode in which the characteristic area specifying unit 8d automatically selects and specifies a foreground area C1 for the subject image D from among the characteristic area C detected by the characteristic area detector 8b and a manually specifying mode for specifying, as a foreground area C1, an area designated by the user in the background image P1 displayed on the display 11.

When capturing the background image P1, one of the automatically and manually specifying modes is selected by the selection/determination pushbutton 12b.

When the user inputs a data indicative of a selected area in the background image P1 using the selection/determination pushbutton 12b in the manually specifying mode, a corresponding signal is forwarded to CPU 13. In accordance with this signal, CPU 13 causes the characteristic area detector 8b to detect a corresponding area as a characteristic area C and also causes the characteristic area specifying unit 8d to specify the image of the area C as a foreground area C1 for the subject image D. The pushbutton 12b and CPU 13 coordinate to compose means for specifying the selected area in the displayed background image P1.

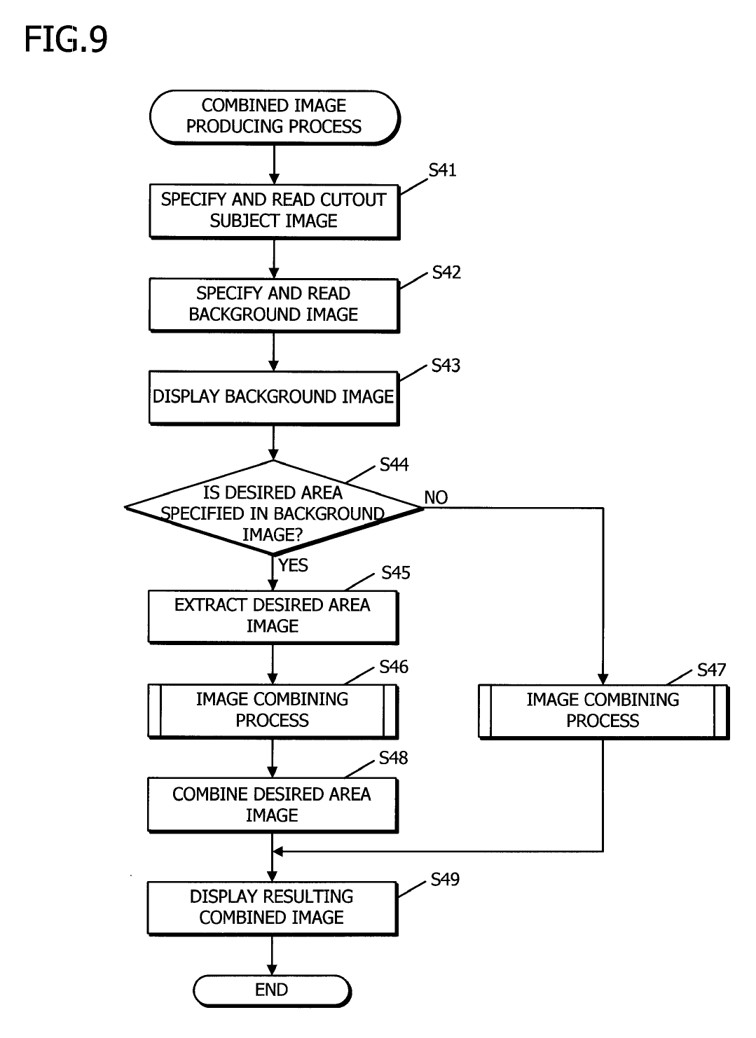

A combined image producing process to be performed by the modification of the camera device 100 when the selection/determination pushbutton 12b is operated in the manually specifying mode will be described with reference to a flowchart of FIG. 9.

As shown in FIG. 9, when a desired non-display area-subject image P2 is selected from among the plurality of images recorded on the recording medium 9 by the operation of the operator input unit 12, the image processing subunit 8 reads image data of the specified non-display area-subject image P2 from the recording medium 9 and then loads it on the image memory 5 (step S41).

When a desired background image P1 is selected from among the plurality of images recorded on the recording medium 9 by the operation of the operator input unit 12, the image combine subunit 8f reads image data of the specified background image P1 from the recording medium 9 and loads it on the image memory 5 (step S42).

Then, CPU 13 causes the display control unit 10 to display, on the display 11, the background image P1 based on its image data loaded on the image memory 5 (step S43). Then, CPU 13 determines whether a signal to designate a desired area in the background image P1 displayed on the display 11 is outputted to CPU 13 and hence whether the desired area is designated in response to the operation of the selection/determination pushbutton 12b (step S44).

If it does (YES in step S44), CPU 13 causes the characteristic area detector 8b to detect the desired area as a characteristic area C; causes the characteristic area specifying unit 8d to specify the detected characteristic area C as a foreground image C1; and then causes characteristic area image reproducer 8e to reproduce the foreground area C1 (step S45).

Then, the image combine subunit 8f performs an image combining process, using the background image P1, whose data is loaded on the image memory 5, and the subject image D of the non-display area-subject image P2 (step S46). Since the image combining process is similar to that of the above embodiment, further description thereof will be omitted.

Then, the image combine control unit 8g causes the image combine subunit 8f to combine a desired area image and a combined image P4 in which the subject image D is superimposed on the background image P1 such that the desired area image becomes a foreground for the subject image D (step S48). Then, CPU 13 causes the image display control unit 10 to display, on the display 11, a combined image in which the desired area image is a foreground for the subject image D, based on the image data of the combined image produced by the image combine subunit 8f (step S49).

When CPU 13 determines that no desired area is specified (NO in step S44), the combine subunit 8f performs an image combine process, using the background image P, whose data is loaded on the image memory 5, and the subject image D contained in the non-display area-subject image P2 (step S47). Since the image combine process is similar to that of the embodiment, further description thereof will be omitted.

Then, CPU 13 moves the combined image processing process to step S49, which displays, on the display 11, the combined image P4 in which the subject image D is superimposed on the background image P1 (step S49), and then terminates the combined image producing process.

As described above, according to the modification of the camera device 100, a desired area of the background image P1 displayed on the display 11 is designated by the operation of the selection/determination pushbutton 12b in the predetermined manner, and the designated area is specified as the foreground image C1. Thus, a tasteful combined image is produced.

Although, for example, in the embodiment, the background image P1 and the subject image D are illustrated as combined such that the image C1 becomes a foreground for the subject image D, the arrangement may be such that a foreground-free image is formed which includes the background image P1 from which the foreground area C1 is extracted; that the foreground-free image is combined with the subject image D; and then that a resulting combined image is further combined with the foreground area C1 such that the foreground area C1 becomes a foreground for the subject image D.

Although in the modification a desired area in the background image P1 displayed on the display 11 is designated by operating the selection/determination pushbutton 12b and specified as a foreground area C1, the present invention is not limited to this example. For example, the arrangement may be such that a characteristic area C detected by the characteristic area detector 8b is displayed on the display 11 in a distinguishable manner and that the user specifies one of the areas C as a foreground area C1.

Although in the modification a desired area is specified by operating the selection/determination pushbutton 12b in a predetermined manner, the display 11 may include a touch panel which the user can touch to specify the desired area.

The characteristic area specifying unit 8d may select and specify a background image C2 to be disposed behind the subject image D from among characteristic areas C detected by the characteristic area detector 8b. Further, from among the areas C, the characteristic area specifying unit 8d may specify a second background area to be disposed behind the subject image D; and combine the background image P1 and the subject image D such that the specified foreground area C1 becomes a foreground for the subject image D and that the specified second background area becomes a background for the subject image D.

The structure of the camera device 100 shown in the embodiment is only as an example, and is not limited to this particular example. Although in the present invention the camera device is illustrated as an image combine apparatus, the image combine apparatus is not limited to the illustrated one, and may be modified in various manners as long as it comprises at least the combine subunit, command detector, image specifying unit, and combine control unit. For example, an image combine apparatus may be constituted such that it receives and records image data of a background image P1 and a non-display area-subject image P2 data and information on the distances from the focus lens to the subjects and characteristic areas produced by an image capturing device different from the camera device 100, and only performs a process for producing a non-display area-subject image.

Although in the embodiment it is illustrated that the functions of the specifying unit and the combined control unit are implemented in the image processing submit 8 under control of the CPU 13, the present invention is not limited to this particular example. These functions may be implemented in predetermined programs with the aid of CPU 13.

More specifically, to this end, a program memory (not shown) may prestore a program including a specified process routine and an image combine control routine. Further, the specified process routine causes CPU 13 to function as means for specifying a foreground area for the subject image D in the background image P1. The combine control routine may cause CPU 13 to function as means for combining the background image P1 and the subject image D such that the foreground area C1 specified in the specifying process routine is for the subject image D.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An image combine apparatus comprising:
a detection unit configured to detect a command to combine a background image and a foreground image;
a specifying unit configured to specify, responsive to the detecting the command, a foreground area to be present over the foreground image; and
a combine subunit configured to combine the background image and the foreground image such that the foreground area is disposed in front of the foreground image.

2. The image combine apparatus of claim 1, wherein:
the combine subunit reproduces the foreground area specified by the specifying unit, and combines the background image and the foreground image such that a resulting reproduced foreground area is disposed in front of the foreground image.

3. The image combine apparatus of claim 1, further comprising:
an image capture unit; and
a distance information acquirer configured to acquire information on a distance from the image capture unit to a subject on which the image capture unit is focused when an image of the subject is captured by the image capture unit; and wherein:
the specifying unit specifies the foreground area based on information on a distance from the image capture unit to the main subject on which the image capture unit is focused when the background image is captured, and information on a distance from the image capture unit to the subject on which the image capture unit is focused when the foreground image is captured.

4. The image combine apparatus of claim 1, wherein:
the foreground image comprises a transparent area.

5. The image combine apparatus of claim 1, further comprising:
a designating unit configured to designate the foreground area arbitrarily to be specified by the specifying unit.

6. A software program product embodied in a computer readable medium for causing the computer to function as:
a detection unit configured to detect a command to combine a background image and a foreground image;
a specifying unit configured to specify, responsive to the detecting the command, a foreground area to be present in front of the foreground image; and
a combine subunit configured to combine the background image and the foreground image such that the foreground area is disposed in front of the foreground image.
